(19) United States
(12) Patent Application Publication
(10) Pub. No.: US 2025/0333044 A1
(43) Pub. Date: Oct. 30, 2025

(54) METHOD FOR GENERATING AND CONFIGURING VEHICLE PARAMETERS AND VEHICLE-MOUNTED DEVICE

(71) Applicant: HON HAI PRECISION INDUSTRY CO., LTD., New Taipei (TW)

(72) Inventor: YU-CHING LIN, New Taipei (TW)

(21) Appl. No.: 18/910,228

(22) Filed: Oct. 9, 2024

(30) Foreign Application Priority Data
Apr. 30, 2024 (CN) 202410542529.X

(51) Int. Cl. B60W 10/30; B60W 50/00; B60W 50/14; G06K 19/06; H04W 4/80

(52) U.S. Cl. CPC B60W 10/30; B60W 50/14; G06K 19/06028; H04W 4/80; B60W 2050/0064; B60W 2540/043

(57) ABSTRACT

A method for generating vehicle parameters is provided in the present application. The method includes obtaining driver information and vehicle information, and obtaining vehicle parameter information based on the vehicle information. According to a correspondence relationship between the driver information and the vehicle information, a correspondence relationship between the driver information and the vehicle parameter information is determined. The vehicle parameter information serves as an information carrier for the vehicle parameters and stores the vehicle parameters. The correspondence relationship between the driver information and the vehicle parameters is determined based on the driver information and the corresponding vehicle parameter information.

### FIELD

The subject matter herein generally relates to a field of vehicle technology, and in

particular to a method for generating and configuring vehicle parameters and a vehicle-mounted device.

### BACKGROUND

Different drivers of different vehicles have different heights, body shapes and personal preferences. Different drivers have different requirements for configuring vehicle parameters of components of a vehicle. The components of the vehicle may include a seat, a rearview mirror and a side mirror, a steering wheel, air conditioning, a window and a sunroof, an entertainment system, a navigation map, a driving mode, a charging setting, a driver assistance system and so on.

When multiple people share the same vehicle, for example, driver A may use the vehicle on odd days, and driver B may use the vehicle on even days. If multiple components of the vehicle need to be adjusted, driver A and driver B need to adjust vehicle parameters corresponding to the multiple components, which is complicated and time-consuming.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

In order to more clearly illustrate a technical solution of an embodiment of the present application, drawings required in description of the embodiment of the present application will be briefly introduced below. Obviously, the drawings described below are only some embodiments of the present application. For those skilled in the art, other drawings can be obtained based on these drawings without paying any creative labor.

FIG. 1 is a block diagram of an application scenario of a method for generating vehicle parameters or a method for configuring vehicle parameters provided in an embodiment of the present application.

FIG. 2 is a flowchart of a method for generating vehicle parameters provided in an embodiment of the present application.

FIG. 3 is a flowchart of an embodiment of a method for configuring vehicle parameters provided in an embodiment of the present application.

FIG. 4 is a structural diagram of a device for generating vehicle parameters provided in an embodiment of the present application.

FIG. 5 is a structural diagram of a device for configuring vehicle parameters provided in an embodiment of the present application.

FIG. 6 is a structural diagram of a vehicle-mounted device provided in an embodiment of the present application.

### DETAILED DESCRIPTION

It should be noted that terms “first” and “second” of the specification, claims and drawings of the present application are used to distinguish similar objects rather than to describe a specific order or sequence.

It should also be noted that a method disclosed in an embodiment or shown in a flowchart of the present application includes one or more steps for implementing the method. Without departing from a scope of the claims, the execution order of multiple steps may be interchanged with each other, and some steps may also be deleted.

Some embodiments will be described below in conjunction with the drawings. The following embodiments and features of the embodiments may be combined with each other without conflict.

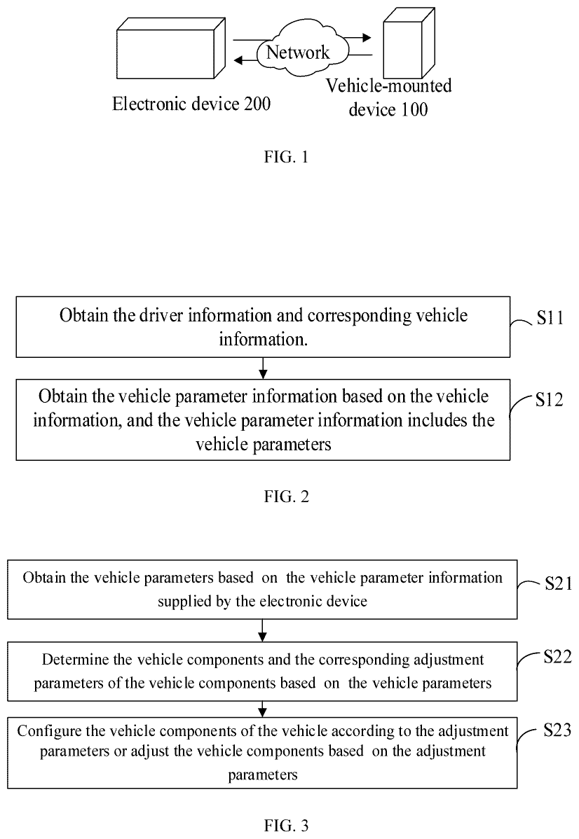

Please refer to FIG. 1, which shows the application scenario of the method for generating vehicle parameters or the method for configuring vehicle parameters provided in the embodiment of the present application. As shown in FIG. 1, a vehicle-mounted device 100 is communicatively connected to an electronic device 200. The vehicle-mounted device 100 is installed in a vehicle.

In some embodiments, when a driver drives the vehicle corresponding to the vehicle-mounted device 100 for the first time, the driver may adjust vehicle components, such as an angle of the driver's seat, an angle of the rearview mirror, etc. In response to an operation of the driver, the vehicle-mounted device 100 obtains driver information and corresponding vehicle sensing data through sensors. The vehicle-mounted device 100 determines vehicle information corresponding to the driver information based on the vehicle sensing data.

In some embodiments, after determining the vehicle information corresponding to the driver information, the vehicle-mounted device 100 stores the vehicle information corresponding to the driver information into a local storage device, or sends the vehicle information corresponding to the driver information to the electronic device 200. The electronic device 200 installs a client corresponding to the vehicle-mounted device 100. A user performs operation to adjust the vehicle information by using the client corresponding to the vehicle-mounted device 100.

In some embodiments, the user edits the driver information and corresponding vehicle information through the client of the vehicle-mounted device 100 installed in the electronic device 200. Among them, the vehicle information includes information such as vehicle components and parameters of the vehicle components. In response to an editing operation of the user, the electronic device 200 obtains the driver information and the vehicle information and establishes a corresponding relationship between the driver information and the vehicle information. The embodiment of the present application does not limit a way in which the electronic device 200 obtains the driver information and the vehicle information.

In some embodiments, the electronic device 200 obtains vehicle parameter information based on the vehicle information. Among them, the vehicle parameter information includes vehicle parameters. The vehicle parameter information stores the vehicle parameters. The vehicle parameter information may be used to represent the stored vehicle parameters, and may be information carrier for the electronic device 200 to transmit the vehicle parameter to the vehicle-mounted device 100. For example, the vehicle parameter information includes a barcode, a near-field communication (NFC) tag, etc., and the vehicle parameters are stored through the barcode and the NFC tag. The vehicle-mounted device 100 obtains the vehicle parameters by scanning the barcode or reading the NFC tag.

When the driver needs to drive the vehicle, the electronic device 200 obtains the driver information and determines the corresponding vehicle parameter information according to the relationship between the driver information and the vehicle parameter information. The electronic device 200 sends the vehicle parameter information to the vehicle-mounted device 100. The vehicle-mounted device 100 configures the vehicle parameters based on the vehicle parameter information provided by the electronic device 200.

In a process of configuring the vehicle parameters of the vehicle, the vehicle-mounted device 100 obtains the vehicle parameters based on the vehicle parameter information provided by the electronic device 200. The vehicle-mounted device 100 determines the vehicle components and corresponding adjustment parameters of the vehicle components based on the vehicle parameter. Then, the vehicle-mounted device 100 configures the parameters of the corresponding vehicle components based on the adjustment parameters or adjusts the vehicle components based on the adjustment parameters.

In some embodiments, the communication connection includes but is not limited to a wired communication connection and a wireless communication connection. The wireless communication connection is established by Near Field Communication (NFC) technology,

Bluetooth technology, Wireless Fidelity (Wi-Fi) technology, etc. The electronic device 200 includes but is not limited to any one of a mobile phone, a tablet computer, a wearable device, etc. The vehicle-mounted device 100 includes but is not limited to an electronic control unit (ECU) of the vehicle, etc.

Please refer to FIG. 2, which shows a flow chart of the implementation of the method for generating vehicle parameters provided in the embodiment of the present application. The method is applied to an electronic device. The embodiment of the present application takes the method applied to the electronic device 200 in FIG. 1 as an example for explanation, and the method includes following steps.

S11: the electronic device obtains the driver information and corresponding vehicle information.

In some embodiments, the vehicle information includes vehicle identification, the vehicle parameters corresponding to vehicle components, etc. Among them, the vehicle identification is used to uniquely identify the vehicle, for example, the vehicle identification may be a license plate number. The driver information includes a nickname of the driver, a driver identification, etc.

In some embodiments, the electronic device is communicatively connected to the vehicle-mounted device. When the driver drives the vehicle corresponding to the vehicle-mounted device for the first time, the driver may adjust the vehicle components, such as the angle of the driver's seat, the angle of the rearview mirror, etc. In response to the operation of the driver, the vehicle-mounted device obtains the driver information and the corresponding vehicle sensing data through sensors. The vehicle-mounted device 100 determines the vehicle information corresponding to the driver information based on the vehicle sensing data. After determining the driver information and the corresponding vehicle information, the vehicle-mounted device stores driver information and the vehicle information in the local storage device, or sends them to the electronic device. The electronic device receives the driver information and the vehicle sensing data sent by the vehicle-mounted device, and determines the driver information and the corresponding vehicle information based on the vehicle sensing data.

In other embodiments, the electronic device may be configured with a client application for remotely managing the vehicle, and the client application may be an application installed in the electronic device. The electronic device may realize connection and interaction with a vehicle management system of the vehicle through the client application. The user may configure the driver information and the corresponding vehicle information through the client application. The electronic device obtains the driver information and the corresponding vehicle information in response to a configuration operation of the user. The embodiment of the present application does not limit a way of obtaining the driver information and the corresponding vehicle information.

In this embodiment, a variety of driver information options, vehicle component options, vehicle model options, vehicle parameter options, etc. may be pre-configured in the client application. When the user sets the vehicle information through the client application, the driver information may be selected from a variety of driver information options, and the vehicle information corresponding to the driver information may be selected from the variety of the vehicle component options, the vehicle model options, the component configuration parameter options, etc.

In some embodiments, the electronic device stores the driver information of one or more drivers, and each driver information may correspond to the vehicle information of one or more vehicles.

S12: the electronic device obtains the vehicle parameter information based on the vehicle information, and the vehicle parameter information includes the vehicle parameters.

In some embodiments, the vehicle parameter information may be used to represent the vehicle parameters and as an intermediate information carrier for the electronic device to transmit the vehicle parameters to the vehicle-mounted device. For example, the vehicle parameter information stores the vehicle parameters by using a barcode, an NFC tag, and so on. The vehicle-mounted device obtains the vehicle parameters by scanning the barcode or reading the NFC tag.

In some embodiments, the electronic device determines the correspondence relationship between the driver information and the vehicle parameter information based on the correspondence relationship between the driver information and the vehicle information, as well as the correspondence relationship between the vehicle information and the vehicle parameter information. As the vehicle parameters may be stored in the vehicle parameter information by using the barcode, the NFC tag, etc., the electronic device determines a correspondence relationship among the driver information, the barcode or the NFC tag and the vehicle parameters based on the correspondence relationship between the driver information and the vehicle parameter information. According to the above correspondence relationships, it is convenient to invoke the corresponding vehicle parameters based on the driver information and configure the vehicle parameters, which overcomes the problem that the driver readjusts the vehicle parameters corresponding to each vehicle component every time he drives, which is complicated and time-consuming.

In some embodiments of the present application, the vehicle parameter information includes information for a barcode corresponding to the vehicle parameters, and a method for the electronic device to generate the barcode includes obtaining the vehicle parameters from the vehicle information and generating the barcode based on the vehicle parameters.

In some embodiments, the electronic device obtains the vehicle parameters corresponding to vehicle components from the vehicle information, such as data of the vehicle components, an adjustment parameter corresponding to the data of the vehicle components, and so on. The electronic device encodes the vehicle parameters corresponding to the vehicle component and generates the corresponding barcode.

In some embodiments, the electronic device obtains a vehicle identification from the vehicle information and establishes a corresponding relationship among the vehicle identification, the driver information and the barcode. The vehicle identification is used to uniquely identify the vehicle, for example, the vehicle identification may be a license plate number, etc.

In some embodiments, when a driver needs to drive a vehicle, the electronic device enters a preset query interface through an operation of the driver. The driver may enter the driver information corresponding to the driver, the vehicle identification of the vehicle and other information through the query interface, and the electronic device searches for the vehicle parameters corresponding to when the driver is driving the vehicle. The electronic device matches the corresponding barcode based on the driver information and vehicle identification and so on. The barcode stores the vehicle parameters when the driver is driving the vehicle. The driver uses a scanning device of the vehicle to scan the barcode, and the vehicle-mounted device obtains the vehicle parameters by scanning the barcode through the scanning device and configures the vehicle parameters.

In some embodiments of the present application, the vehicle parameters include the data of the vehicle components and the adjustment parameters corresponding to these data. The electronic device generates the barcode based on the vehicle parameters, which involves generating the barcode using the data of the vehicle components and the corresponding adjustment parameters.

In some embodiments, the data of the vehicle components may include names of multiple vehicle components. Among them, the vehicle components include but are not limited to, the seat, the rearview mirror and the side mirror, the steering wheel, the air conditioning, the window and the sunroof, the entertainment system, the navigation map, the driving mode, the charging setting, the driver assistance system and so on. The adjustment parameters corresponding to the data of the vehicle components. For example, the adjustment parameters corresponding to the seat may include a height of the seat, an inclined angle of the seat, an anteroposterior position of the seat, etc.

In some embodiments, the electronic device converts the data of the vehicle components and the adjustment parameters corresponding to the data of the vehicle components into the barcode through a barcode generation software or barcode generation library. For example, the barcode generation software includes a Barcode Generator, a Barcode Studio, a QR Code Generator, etc. For example, the barcode generation library includes a barcode of Python, a qrcode library of the Python, and a ZXing library of Java, etc.

In some embodiments of the present application, the electronic device sets an identification of an appearance of the barcode based on a preset configuration instruction, and the identification of the appearance of the barcode corresponds to the barcode.

In some embodiments, in order to ensure a difference in the barcode and make it easy to identify different barcodes, the characteristics of the identification of the appearance of the barcode are set by a user through an account. For example, the user sets color, text, image and other characteristic identifications for the barcode. After the user sets the identification of the appearance for each barcode, the corresponding preset configuration instruction is triggered, and the electronic device configures the corresponding identification of the appearance to the generated barcode based on the preset configuration instruction. Among them, in order to increase recognition of the barcode, the barcode corresponds to the identification of the appearance of the barcode. That is, each barcode corresponds to a unique identification of the appearance of the barcode.

In the embodiment of the present application, the electronic device stores the vehicle parameters through the barcode, so that the vehicle parameters are visualized. The vehicle-mounted device obtains the vehicle parameters by scanning the barcode, which is simple to operate, time-saving, and convenient for improving the configuration efficiency of the vehicle parameters.

In some embodiments of the present application, the electronic device writes the driver information, vehicle identification and the vehicle parameters into the NFC tag.

In some embodiments, the vehicle-mounted device and the electronic device have a function to support near-field communication (NFC). An NFC sensing area is set in the vehicle-mounted device. When the vehicle-mounted device is establishing a near-field communication connection with the electronic device, the vehicle-mounted device and the electronic device both enable the NFC function, and the vehicle-mounted device searches for nearby devices supporting the NFC function. When the electronic device is close to the NFC sensing area of the vehicle-mounted device, the vehicle-mounted device detects that the electronic device is present. The vehicle-mounted device sends a connection request to the electronic device, and the electronic device responds to the connection request to establish a near-field communication connection with the vehicle-mounted device. After the vehicle-mounted device and the electronic device establish a near-field communication connection, the electronic device exchanges data with the vehicle-mounted device. For example, the electronic device sends data about the vehicle component, corresponding adjustment parameters, and other vehicle parameters to the vehicle-mounted device.

The electronic device writes the driver information, the vehicle identification and the vehicle parameters into the NFC tag. After the electronic device and the vehicle-mounted device establish the near field communication connection, the electronic device obtains the corresponding vehicle parameters from the NFC tag based on the driver information and the vehicle identification. The vehicle identification is corresponding to the vehicle which installed the vehicle-mounted device. It then sends the vehicle parameters to the corresponding vehicle-mounted device through the near field communication connection.

The method for generating vehicle parameters is provided in an embodiment of the present application. The method obtains and stores driver information and corresponding vehicle information and obtains the vehicle parameter information based on the vehicle information. According to the correspondence relationship between the driver information and the vehicle information, the correspondence relationship between the driver information and the vehicle parameter information is determined. Since the vehicle parameter information may be used as an information carrier for the vehicle parameters to store the vehicle parameters. The correspondence relationship between the driver information and the vehicle parameters is determined based on the driver information and the corresponding vehicle parameter information. Among them, the vehicle parameters include the adjustment parameters of the vehicle components that the driver needs to configure while driving the vehicle. According to the above correspondence relationship, it is convenient to retrieve the vehicle parameters and configure the vehicle parameters based on the driver information. Thereby overcoming the problem that the driver must readjust the vehicle parameters corresponding to each vehicle component every time he drives, which is complicated and time-consuming.

Please refer to FIG. 3, FIG. 3 is a flowchart of an implementation of a method for configurating vehicle parameters in the embodiment of the present application. The method is applied to a vehicle-mounted device, which is installed in a vehicle. The embodiment of the present application is described by taking the method applied to the vehicle-mounted device 100 of FIG. 1 as an example, and the method includes the following steps.

S21, the vehicle-mounted device obtains the vehicle parameters based on the vehicle parameter information supplied by the electronic device.

In some embodiments, the vehicle parameter information includes the barcode or

the NFC tag, etc. The vehicle parameters include the data of the vehicle components and the corresponding adjustment parameters.

In some embodiments, the vehicle-mounted device obtains the vehicle parameters by reading the barcode provided by the electronic device. Alternatively, the vehicle-mounted device receives the vehicle parameters sent by the electronic device by establishing the near-field communication connection with the electronic device.

It should be noted that before obtaining the vehicle parameters based on the vehicle parameter information provided by the electronic device, the electronic device needs to obtain the driver information and the corresponding vehicle identification and obtain the corresponding vehicle parameter information based on the driver information and the corresponding vehicle identification. For example, the electronic device matches the corresponding barcode based on the driver information and the corresponding vehicle identification.

In some embodiments, the electronic device obtains the driver information and vehicle identification according to an operation input by the user. The embodiment of the present application does not limit the method of obtaining the driver information and vehicle identification.

In other embodiments, the driver selects the corresponding barcode by using the electronic device. The embodiment of the present application does not limit the method of determining the barcode for scanning by the vehicle-mounted device.

In some embodiments of the present application, the vehicle parameter information includes the barcode corresponding to the vehicle. The vehicle-mounted device obtains the vehicle parameters based on the vehicle parameter information provided by the electronic device, which includes: determining initial vehicle components corresponding to the barcode and initial adjustment parameters corresponding to the initial vehicle components by identifying the barcode provided by the electronic device; in response that the vehicle includes all the initial vehicle components, determining the initial vehicle components as the vehicle components, and determining the adjustment parameters corresponding to the vehicle components based on the initial adjustment parameters corresponding to the initial vehicle component.

In some embodiments, the vehicle-mounted device collects an image of the barcode provided by an electronic device through an image acquisition device or a scanning device. The vehicle-mounted device obtains the initial vehicle components corresponding to the barcode and the initial adjustment parameters corresponding to the initial vehicle components by identifying and analyzing the barcode.

In some embodiments, the vehicle-mounted device analyzes the barcode through relevant algorithms, such as Zxing algorithm, OpenCV algorithm, etc.

Assuming that the driver wants to drive a vehicle, the driver inputs the driver information and the vehicle identification of the vehicle into the electronic device, and the electronic device searches for the corresponding barcode based on the driver information and the vehicle identification and displays the barcode. Alternatively, the driver selects the corresponding barcode from the electronic device. The vehicle-mounted device scans the barcode and obtains the vehicle parameters when the driver configures the vehicle. However, there is a situation that the barcode is invalid, such as the driver selects an invalid barcode. If the barcode is invalid, the vehicle components and corresponding component adjustment parameters obtained by the vehicle-mounted device may not match the vehicle, which may cause the vehicle-mounted device to fail to configure the vehicle or be unable to implement vehicle configuration, affecting the user experience and even causing driving safety risks.

To solve the above problem, the vehicle-mounted device parses the barcode, obtains the initial vehicle components of the barcode and the initial adjustment parameters corresponding to the initial vehicle components, and further determines whether the barcode is valid based on the initial vehicle components to avoid the inability to implement vehicle configuration due to mismatch between the vehicle and the vehicle components.

In some embodiments, the vehicle-mounted device determines the validity of the barcode by checking whether the vehicle includes the initial vehicle components. For example, if the vehicle contains all the initial vehicle components, the vehicle-mounted device determines that the barcode is valid, and sets the initial vehicle components as vehicle components, and uses the initial adjustment parameters corresponding to the initial vehicle components as the adjustment parameters corresponding to the vehicle components. If it is determined that the vehicle does not include any initial vehicle components, it is determined that the barcode is invalid. Then, the vehicle-mounted device generates a prompt message to prompt the driver that the barcode does not match the vehicle and recommends re-supplying the barcode.

In some embodiments, in response that the vehicle includes some initial vehicle components, the vehicle-mounted device determines the vehicle does not include other initial vehicle components and generates a first prompt message based on the other initial vehicle components. The first prompt message is used to prompt information associated with other initial vehicle components.

In some embodiments, the other initial vehicle components not included in the vehicle can be referred to as additional vehicle components.

During the use of the vehicle, some vehicle components may be removed according to the specific needs and configuration of the user. For example, some trucks or light commercial vehicles remove rear seats to increase space for storing cargo. If the vehicle components of the vehicle are removed without deleting information of vehicle components in the electronic device, it may result in that during the process of configuring the vehicle parameters of the vehicle, the vehicle-mounted device of the vehicle scans the barcode and determines that the vehicle only includes some of the initial vehicle components. In this case, the vehicle-mounted device further determines other initial vehicle components not included in the vehicle and generates a first prompt message based on the other initial vehicle components. The vehicle-mounted device displays the first prompt message through a display screen of the vehicle or sends the first prompt message to the electronic device to prompt the user that the other initial vehicle components are present and will not be configured. The user determines a reason why the other initial vehicle components will not be configured by analyzing the first prompt message. The reason includes, but is not limited to, an error in the barcode or the data of the vehicle components not being updated in time.

In some embodiments, if it is determined that the barcode is invalid, the user (driver) re-provides the barcode through the electronic device. If it is determined that the data of the vehicle components is not updated in time, the user (driver) ignores the other initial vehicle components and continue to configure some of the initial vehicle components included in the vehicle.

In some embodiments, when displaying the first prompt information, the vehicle-mounted device provides multiple processing options, such as an option to ignore and continue to the next step, an option to re-determine the barcode, etc.

In some embodiments of the present application, the vehicle parameter information includes an NFC tag. The vehicle-mounted device obtains the vehicle parameters based on the vehicle parameter information provided by the electronic device including: establishing a near-field communication connection with the electronic device; reading the vehicle parameters corresponding to the vehicle from the NFC tag.

In some embodiments, the electronic device writes the driver information, the vehicle identification and the vehicle parameters into the NFC tag and establishes a corresponding relationship among the driver information, the vehicle identification, the vehicle parameters and the NFC tag.

During the process of configuring the vehicle parameters for the vehicle, the electronic device may obtain the driver information and the vehicle identification and match the corresponding NFC tag based on the driver information and the vehicle identification. After the electronic device establishes the near-field communication connection with the vehicle-mounted device, the electronic device sends the vehicle parameters of the NFC tag to the vehicle-mounted device via the near-field communication connection.

In other embodiments, the vehicle-mounted device obtains the driver information and the vehicle identification of the vehicle to which it belongs. After the electronic device establishes the near-field communication connection with the vehicle-mounted device, the vehicle-mounted device sends the driver information and the vehicle identification to the electronic device via the near-field communication connection. The electronic device matches the corresponding NFC tag based on the driver information and the vehicle identification and obtains the vehicle parameters from the NFC tag. The electronic device then sends the vehicle parameters to the vehicle-mounted device through the near-field communication connection.

In other embodiments, the electronic device may write the driver information, the vehicle identification, the vehicle parameters, and the corresponding relationship among the driver information, the vehicle identification and the vehicle parameters into the NFC tag. In the process of configuring the vehicle parameters for the vehicle, the vehicle-mounted device sends the driver information and the vehicle identification to the electronic device through the near-field communication connection. The electronic device may read the corresponding vehicle parameters from the NFC tag based on the driver information and the vehicle identification and send the vehicle parameters to the vehicle-mounted device via the near-field communication connection.

In another embodiment, the electronic device pre-stores a mapping table of the driver information, the vehicle identification, and the vehicle parameters. After the vehicle-mounted device establishes the near-field communication connection with the electronic device, the vehicle-mounted device may send the driver information and the vehicle identification to the electronic device. The electronic device may determine the vehicle parameters based on the mapping table and send the vehicle parameters to the vehicle-mounted device through the near-field communication connection.

In another embodiment, the vehicle-mounted device pre-stores the mapping table of the driver information, the vehicle identification, and the vehicle parameters. After the vehicle-mounted device establishes the near-field communication connection with the electronic device, the electronic device sends the driver information to the vehicle-mounted device, and the vehicle-mounted device determines the vehicle parameters based on the driver information, the vehicle identification of the vehicle, and the pre-stored mapping table. The embodiment of the present application does not limit the way in which the vehicle-mounted device obtains the vehicle parameters through the near-field communication connection with the electronic device.

S22, the vehicle-mounted device determines the vehicle components and the corresponding adjustment parameters of the vehicle components based on the vehicle parameters.

S23, the vehicle-mounted device configures the vehicle components of the vehicle based on the adjustment parameters or adjusts the vehicle components based on the adjustment parameters.

In some embodiments, after determining the vehicle components to be adjusted and the corresponding adjustment parameters, the vehicle-mounted device sets the parameters of the corresponding vehicle components in the vehicle as the adjustment parameters. For example, the vehicle-mounted device determines that the vehicle components include the seat and a left rearview mirror, and the corresponding adjustment parameters include the height of the seat and the angle of the left rearview mirror. The height of the seat is equal to 20 cm and the angle of the left rearview mirror is equal to 30°. Then, the vehicle-mounted device configures the height of the seat to 20 cm and the angle of the left rearview mirror to 30° based on the adjustment parameters corresponding to the vehicle components thereby achieving the adjustment of the seat and the left rearview mirror.

In some embodiments, after determining the vehicle components and the corresponding adjustment parameters, the vehicle-mounted device also adjusts the corresponding vehicle components based on the adjustment parameters. For example, the vehicle component is a window, and the corresponding adjustment parameter is set to partially open. In this case, after the electronic device determines the vehicle components and the corresponding adjustment parameters, the corresponding vehicle components are adjusted based on the adjustment parameters. For example, the window is partially opened based on the adjustment parameters.

In some embodiments of the present application, in the process of configuring parameters of vehicle components of the vehicle based on adjustment parameters, or adjusting vehicle components based on adjustment parameters, the vehicle-mounted device further determines whether the vehicle components and the adjustment parameters corresponding to the vehicle components meet optimization settings of the vehicle. If it is determined that the vehicle components do not meet the optimization settings, a second prompt message is generated based on the optimization settings to indicate that the vehicle components need to be adjusted. And/or if it is determined that the adjustment parameters do not meet the optimization settings, a third prompt message is generated based on the optimization settings to indicate that the adjustment parameters need to be adjusted.

In some embodiments, there are pre-set optimization settings for the relationships between the vehicle components of the vehicle and the adjustment parameters corresponding to the vehicle components. The relationships between the vehicle components of the vehicle and the adjustment parameters corresponding to the vehicle components of the vehicle all reach the optimization settings, which can make the vehicle reach a better state, ensure the driving safety of the vehicle and improve the user experience. For example, the default optimization setting of the vehicle-mounted device is “When the driver wants to adjust the navigation system and the driving mode, the charging settings also need to be adjusted together. That is, the navigation system and the driving mode need to be adjusted in association with the charging settings.” If the vehicle components include settings for the navigation system and the driving mode but do not include settings for charging, then the vehicle-mounted device determines that the navigation system and the driving mode of the vehicle do not meet the optimization settings. Then, the vehicle-mounted device generates the second prompt message based on the vehicle components that do not meet the optimization settings and the corresponding optimization settings, indicating that the vehicle components should be adjusted. For example, when the vehicle components only include the navigation system and the driving mode, the second prompt message is triggered to prompt the driver to adjust the charging settings while adjusting the navigation system and the driving mode to prevent the vehicle from running out of power during driving, which would affect the vehicle's operation. The driver can manually adjust the vehicle components, or supplement or delete the vehicle components through electronic devices. The second prompt message is “whether to adjust the charging settings.”.

In some embodiments, when it is determined that the adjustment parameters do not meet the optimization setting. For example, the height of the seat does not meet the optimization setting, the vehicle-mounted device generates a third prompt message based on the optimization setting to indicate the driver to adjust the adjustment parameters.

In some embodiments, the vehicle-mounted device displays the second prompt message or the third prompt message on the vehicle's display screen, or sends the second prompt message or the third prompt message to the electronic device. The electronic device adjusts the corresponding vehicle components after receiving the second prompt message and adjusts the corresponding adjustment parameters after receiving the third prompt message.

The method for configurating vehicle parameters is provided in an embodiment of the present application. It is necessary to configure the vehicle parameters of the vehicle components of the vehicle when the driver drives the vehicle. Before the vehicle configures the vehicle parameters, the electronic device obtains corresponding vehicle parameter information based on the driver information and provides the vehicle parameter information to the vehicle. The vehicle obtains the vehicle parameters based on the vehicle parameter information provided by the electronic device via the vehicle-mounted device. The vehicle components and the corresponding adjustment parameters of the vehicle component are determined based on the vehicle parameters. Based on the adjustment parameters, the corresponding vehicle components in the vehicle are configured with parameters, or the corresponding vehicle components are adjusted based on the adjustment parameters. The use of this method can effectively improve the efficiency of vehicle configuration.

It should be understood that the sequence number of the steps in the above embodiment do not indicate the execution order. The execution orders should be determined by the function and internal logic of each step, without limiting the implementation process of the embodiment of the present application.

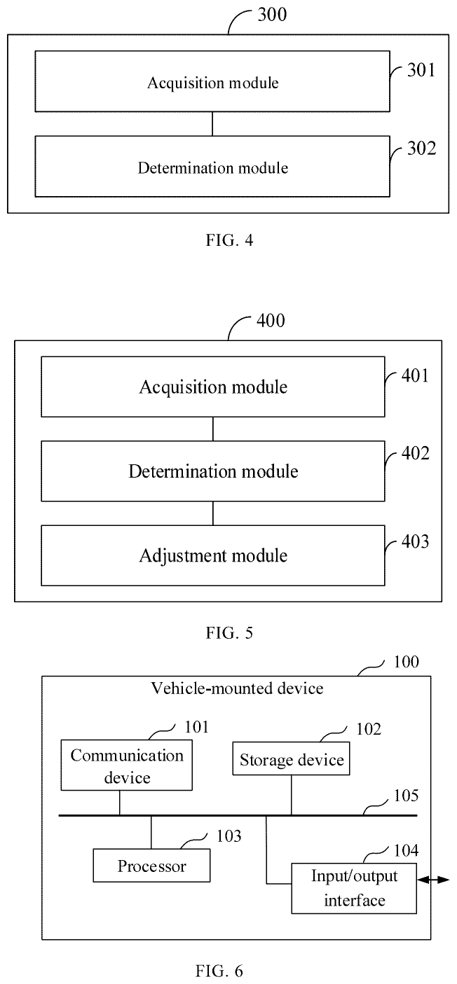

In one embodiment of the present application, an apparatus 300 for generating vehicle parameters is provided, which is applied to an electronic device. The functions that the apparatus 300 may implement correspond to the method for generating the vehicle parameters in the above-mentioned embodiment. As shown in FIG. 4, the apparatus 300 for generating vehicle parameters includes an acquisition module 301 and a determination module 302. Each functional module is described in detail as follows: the acquisition module 301 is used to acquire driver information and corresponding vehicle information, and the determination module 302 is used to acquire vehicle parameter information based on the vehicle information, where the vehicle parameter information stores the vehicle parameters, and the driver information corresponds to the vehicle parameter information.

For specific limitations on the apparatus 300, please refer to the above limitations on the vehicle parking method, which will not be described again here. Each module in the apparatus 300 can be implemented in whole or in part by software, hardware, and combinations thereof. Each of the modules may be embedded in or independent of the processor of the computer device in the form of hardware or may be stored in the storage device of the computer device in the form of software, so that the processor can invoke and execute the operations corresponding to the above modules.

In one embodiment of the present application, an apparatus 400 for configuring vehicle parameters is provided, which is applied to a vehicle-mounted device, which is installed in a vehicle, and the vehicle-mounted device may be communicatively connected with an electronic device. The functions that can be implemented by the apparatus 400 for configure vehicle parameters correspond to the method for configurating vehicle parameters in the above-mentioned embodiment. As shown in FIG. 5, apparatus 400 for configuring vehicle parameters includes an acquisition module 401, a determination module 402 and an adjustment module 403. Each functional module is described in detail as follows: an acquisition module 401, which is used to acquire vehicle parameters based on vehicle parameter information provided by an electronic device; a determination module 402, which is used to determine vehicle components and adjustment parameters corresponding to the vehicle components based on the vehicle parameters; an adjustment module 403, which is used to configurate the vehicle parameters corresponding vehicle components in the vehicle based on the adjustment parameters, or to adjust corresponding vehicle components based on the adjustment parameters.

For specific limitations on the apparatus 400, please refer to the above limitations on the vehicle parking method, which will not be described again here. Each module in the apparatus 400 can be implemented in whole or in part by software, hardware, and combinations thereof. Each of the modules may be embedded in or independent of the processor of the computer device in the form of hardware or may be stored in the storage device of the computer device in the form of software, so that the processor can invoke and execute the operations corresponding to the above modules.

Please refer to FIG. 6, which shows a schematic structural diagram of a vehicle-mounted device provided by an embodiment of the present application. A network where the vehicle-mounted device 100 is located includes but is not limited to the Internet, a wide area network, a metropolitan area network, a local area network, a virtual private network (VPN), etc.

As shown in FIG. 6, the vehicle-mounted device 100 includes a communication device 101, a storage device 102, a processor 103, an input/output (I/O) interface 104 and a bus 105. The processor 103 is coupled to the communication device 101, the storage device 102, and the input/output interface 104 through the bus 105, respectively.

The communication device 101 may be a wireless communication device or a mobile communication device. The wireless communication device may provide wireless communication solutions applied to the vehicle-mounted device 100 including a wireless local area network (WLAN) (for example, wireless fidelity (Wi-Fi) network), a Bluetooth (BT), and a global navigation satellite system (GNSS), a frequency modulation (FM), a near field communication (NFC), an Infrared (IR) and other wireless communication solutions. The mobile communication device may provide wireless communication solutions including 2G/3G/4G/5G applied to the vehicle-mounted device 100.

The storage device 102 may include one or more random access memories (RAM) and one or more non-volatile memories (NVM). The random-access memory may be directly read and written by the processor 103, may be used to store executable programs (such as machine instructions) of the operating system or other running programs, and may also be used to store user data and application data, etc. The random-access memory may include a static random-access memory (SRAM), a dynamic random-access memory (DRAM), a synchronous dynamic random-access memory (SDRAM), a double data Rate Synchronous Dynamic Random-access memory (DDR SDRAM, for example, the fifth generation DDR SDRAM is generally called DDR5 SDRAM), etc.

The non-volatile memory may also store executable programs and user data and application data, etc., and may be loaded into the random-access memory in advance for direct reading and writing by the processor 103. The non-volatile memory may include a disk storage device and a flash memory.

The storage device 102 is used to store one or more computer programs. The one or more computer programs are configured for execution by processor 103. The one or more computer programs include a plurality of instructions. When the plurality of instructions is executed by the processor 103, the method for generating the vehicle parameters or the method for configurating the vehicle parameters executed on the vehicle-mounted device 100 can be implemented.

In other embodiments, the vehicle-mounted device 100 further includes an interface for connecting to an external storage device to expand a storage capacity of the vehicle-mounted device 100.

The processor 103 may include one or more processing units. For example, the processor 103 may include an application processor (AP), a modem processor, a graphics processing unit (GPU), and an image signal processor (ISP), a controller, a video codec, a digital signal processor (DSP), a baseband processor, and/or neural-network processing unit (NPU), etc. Among them, different processing units can be independent devices or the different processing units can be integrated in one or more processors.

The processor 103 provides computing and control capabilities. For example, the processor 103 is used to execute a computer program stored in the storage device 102 to implement the method for generating the vehicle parameters or the method for configurating the vehicle parameters.

The I/O interface 104 is used to provide a channel for user input or output. For example, the I/O interface 104 can be used to connect various input and output devices, such as a mouse, a keyboard, a touch device, a display screen, etc., so that the user may input information, or make the information be visualized.

The bus 105 is at least used to provide a channel for a mutual communication among the communication device 101, the storage device 102, the processor 103, and the I/O interface 104 in the vehicle-mounted device 100.

It can be understood that the structure illustrated in the embodiment of the present application does not constitute a specific limitation on the vehicle-mounted device 100. In other embodiments of the present application, the vehicle-mounted device 100 may include more or fewer components than shown in the figure, or some components may be combined, some components may be separated, or some components may be arranged differently. The components illustrated may be implemented in hardware, software, or a combination of software and hardware.

Embodiments of the present application also provide a computer-readable storage medium. A computer program is stored on the computer-readable storage medium. The computer program includes program instructions. The method implemented when the program instructions are executed may refer to the vehicle parking method or the vehicle finding method in each of the above embodiments.

The computer-readable storage medium may be an internal storage device of the computer device described in the above embodiment, such as a hard disk or a memory of the computer device. The computer-readable storage medium may also be an external storage device of the computer device, such as a plug-in hard disk, a smart media card (SMC), or a secure digital (SD) card, a flash card equipped on the computer device.

Further, the computer-readable storage medium may mainly include a storage program area and a storage data area, among them, the storage program area may store an operating system, an application program required for at least one function, etc.; the storage data area may store data created based on the use of the computer device.

Finally, it should be noted that the above embodiments are only used to illustrate the technical solutions of the present application and are not limiting. Although the present application has been described in detail with reference to the preferred embodiments, those of ordinary skill in the art should understand that the technical solutions of the present application can be modified. Modifications or equivalent substitutions may be made without departing from the spirit and scope of the technical solution of the present application.

What is claimed is:

1. A method for generating vehicle parameters, applied to an electronic device, the method comprising:
obtaining driver information and vehicle information; and
obtaining vehicle parameter information based on the vehicle information, the vehicle parameter information comprising vehicle parameters, and the driver information corresponding to the vehicle parameter information.

2. The method according to claim 1, wherein the vehicle parameter information comprises information for a barcode corresponding to the vehicle parameters, the obtaining the vehicle parameter information based on the vehicle information comprising:
obtaining the vehicle parameters from the vehicle information; and
generating the barcode based on the vehicle parameters.

3. The method according to claim 2, wherein the vehicle parameters comprise data of vehicle components and adjustment parameters corresponding to the data of the vehicle components, the generating the barcode based on the vehicle parameters comprises:
generating the barcode based on the data of the vehicle components and the adjustment parameters corresponding to the data of the vehicle components.

4. The method according to claim 1, wherein the electronic device establishes a near-field communication connection with a vehicle-mounted device, the vehicle information comprises a vehicle identification, the method further comprises:
writing the driver information, the vehicle identification and the vehicle parameters into a near-field communication tag.

5. The method according to claim 1, wherein the electronic device communicates with a vehicle-mounted device, and obtaining the driver information and the vehicle information comprises:
receiving the driver information and vehicle sensing data sent by the vehicle-mounted device;
determining the vehicle information corresponding to the driver information based on the vehicle sensing data.

6. A method for configuring vehicle parameter, applied to a vehicle-mounted device, the vehicle-mounted device installable in a vehicle, the method comprising:
obtaining vehicle parameters based on vehicle parameter information supplied by an electronic device;
determining vehicle components and adjustment parameters corresponding to the vehicle components based on the vehicle parameters; and
configuring the vehicle components based on the adjustment parameters or adjusting the vehicle components based on the adjustment parameters.

7. The method according to claim 6, wherein the vehicle parameter information comprises a barcode corresponding to the vehicle, and obtaining the vehicle parameters based on the vehicle parameter information provided by the electronic device comprises:
determining initial vehicle components corresponding to the barcode and initial adjustment parameters corresponding to the initial vehicle components by identifying the barcode provided by the electronic device;
in response to the vehicle comprises the initial vehicle components, determining that the initial vehicle components to be the vehicle components, and determining the adjustment parameters corresponding to the vehicle components based on the initial adjustment parameters corresponding to the initial vehicle components.

8. The method according to claim 6, wherein the vehicle parameter information comprises a near-field communication tag, and the obtaining of the vehicle parameters based on the vehicle parameter information supplied by the electronic device comprises:
establishing a near-field communication connection with the electronic device;
reading the vehicle parameters corresponding to the vehicle from the near-field communication tag.

9. The method according to claim 6, the method further comprising:
determining whether the vehicle components and the adjustment parameters corresponding to the vehicle components meet optimization settings of the vehicle;
generating a second prompt message based on the optimization settings and indicating that the vehicle components need to be adjusted in response that the vehicle components do not meet the optimization settings; and/or
generating a third prompt message based on the optimization settings and indicating that the adjustment parameters need to be adjusted in response that the adjustment parameters do not meet the optimization settings.

10. A vehicle-mounted device comprising:
a storage device;
at least one processor; and
the storage device storing one or more programs that, when executed by the at least one processor, cause the at least one processor to:
obtain vehicle parameters based on vehicle parameter information supplied by an electronic device;
determine vehicle components and adjustment parameters corresponding to the vehicle components based on the vehicle parameters; and
configure the vehicle components based on the adjustment parameters or adjusting the vehicle components based on the adjustment parameters.

11. The vehicle-mounted according to claim 10, wherein the vehicle parameter information comprises a barcode corresponding to the vehicle, the at least one processor obtains the vehicle parameters based on the vehicle parameter information supplied by the electronic device by:
determining initial vehicle components corresponding to the barcode and initial adjustment parameters corresponding to the initial vehicle components by identifying the barcode provided by the electronic device;
in response that the vehicle comprises the initial vehicle components, determining the initial vehicle components to be the vehicle components, and determining the adjustment parameters corresponding to the vehicle components based on the initial adjustment parameters corresponding to the initial vehicle components.

12. The vehicle-mounted according to claim 10, wherein the vehicle parameter information comprises a near-field communication tag, the at least one processor obtains the vehicle parameters based on the vehicle parameter information supplied by the electronic device by:
establishing a near-field communication connection with the electronic device;
reading the vehicle parameters corresponding to the vehicle from the near-field communication tag.

13. The vehicle-mounted according to claim 10, wherein the at least one processor is further caused to:
determine whether the vehicle components and the adjustment parameters corresponding to the vehicle components meet optimization settings of the vehicle;
generate a second prompt message based on the optimization settings and indicate that the vehicle components need to be adjusted in response that the vehicle components do not meet the optimization settings; and/or
generate a third prompt message based on the optimization settings and indicate that the adjustment parameters need to be adjusted in response that the adjustment parameters do not meet the optimization settings.
